(19) United States
(12) Patent Application Publication
(10) Pub. No.: US 2023/0091943 A1
(43) Pub. Date: Mar. 23, 2023

(54) POSITIVE DISPLACEMENT PRESSURIZING/DEPRESSURIZING PUMP

(71) Applicant: ADVICS CO., LTD., Kariya-shi, Aichi-ken (JP)

(72) Inventor: Tomoo HARADA, Kariya-shi, Aichi-ken (JP)

(73) Assignee: ADVICS CO., LTD., Kariya-shi, Aichi-ken (JP)

(21) Appl. No.: 17/909,181

(22) PCT Filed: Mar. 26, 2021
(86) PCT No.: PCT/JP2021/012880

§ 371 Date: Sep. 2, 2022

(30) Foreign Application Priority Data
Mar. 31, 2020 (JP) 2020-061848

(51) Int. Cl. F04B 1/0408

(52) U.S. Cl. CPC F04B 1/0408; B60T 13/148

(57) ABSTRACT

A pump includes: fluid delivery portions each including a volume variable mechanism, a first port and a second port, and a valve mechanism; and a pump flow path formed by the three or more fluid delivery portions being connected in series, in which a movement range of each of pistons includes a maximum volume position, a minimum volume position, and a switching position, and the pump flow path is configured such that a closing movement process (movement between switching position and minimum volume position) in which the piston moves between the switching position and the minimum volume position by driving of a drive device is sequentially shifted from a first inlet/outlet port toward a second inlet/outlet port or from the second inlet/outlet port toward the first inlet/outlet port among the fluid delivery portions

### TECHNICAL FIELD

The present disclosure relates to a positive displacement pressurizing/depressurizing pump.

### BACKGROUND ART

In some vehicle braking devices, an electric cylinder for adjusting the hydraulic pressure of a wheel cylinder is provided, as described in DE 10 2017 214 859 A1, for example. When the wheel cylinder is pressurized/depressurized, the vehicle braking device causes a piston in the electric cylinder to move by an electric motor, thereby decreasing or increasing the volume of an output chamber sectioned by the cylinder and the piston.

### CITATION LIST

### Patent Literature

PTL 1: DE 10 2017 214 859 A1

### SUMMARY

### Technical Problem

Here, the electric cylinder has limit values of the pressurization and depressurization determined in accordance with the volume of the output chamber, constitutionally. In other words, when the piston is brought into contact with a bottom surface of the cylinder and the volume of the output chamber becomes the minimum value, the electric cylinder cannot further pressurize the wheel cylinder. In a case of the depressurization, similarly, for example, when the piston is brought into contact with a surface opposite to the bottom surface, the further depressurization is impossible. In order to extend the range of the pressurization/depressurization (pressurization/depressurization allowable range of the hydraulic pressure), the volume of the output chamber needs to be increased, which upsizes the device.

An object of the present disclosure is to provide a new positive displacement pressurizing/depressurizing pump capable of extending the range of the pressurization/depressurization without upsizing the device, and pressurizing/depressurizing an object of hydraulic pressure control.

### Solution to Problem

A positive displacement pressurizing/depressurizing pump according to the present disclosure includes: a fluid delivery portion including a volume variable mechanism that is configured so as to change a volume of a hydraulic chamber with movement of a piston, a first port and a second port that are open to the hydraulic chamber, and a valve mechanism that causes the first port to open and close in accordance with the movement of the piston; a pump flow path, when connection in series is defined as a state where with respect to the two fluid delivery portions, the first port of one of the fluid delivery portions is connected to the second port of the other fluid delivery portion, formed by the three or more fluid delivery portions being connected in series; and a drive device that causes each of the pistons to move, in which the first port of the fluid delivery portion that is positioned at one end portion of the pump flow path constitutes a first inlet/outlet port, the second port of the fluid delivery portion that is positioned at the other end portion of the pump flow path constitutes a second inlet/outlet port, a movement range of each of the pistons includes a maximum volume position at which a state of the first port is an open state and the volume of the hydraulic chamber becomes maximum, a minimum volume position at which the state of the first port is a closed state and the volume of the hydraulic chamber becomes minimum, and a switching position at which the state of the first port is switched from the open state to the closed state when the piston has moved from the maximum volume position toward the minimum volume position, and the pump flow path is configured such that a closing movement process in which the piston moves between the switching position and the minimum volume position by driving of the drive device is sequentially shifted from the first inlet/outlet port toward the second inlet/outlet port or from the second inlet/outlet port toward the first inlet/outlet port among the fluid delivery portions.

### Advantageous Effects

With the present disclosure, when the closing movement process is executed, the piston changes the volume of the hydraulic chamber while interrupting the pump flow path. Due to the reduction in the volume of the hydraulic chamber in the closing movement process, the fluid is discharged from the second port, whereas due to the increase in the volume of the hydraulic chamber in the closing movement process, the fluid is sucked into the second port. The execution of the closing movement process in each of the fluid delivery portions is sequentially shifted in the pump flow path, whereby the fluid is sucked from one inlet/outlet port and is discharged into the other inlet/outlet port. Accordingly, an object of hydraulic pressure control can be pressurized until the fluid in a fluid suction object (for example, a reservoir) is run out. In a case where the object of hydraulic pressure control is depressurized, the drive device may be driven such that the closing movement process is shifted in the reverse order of the pressurization. In this manner, with the present disclosure, it is possible to extend the range of pressurization/depressurization without upsizing the device, and pressurize/depressurize an object of hydraulic pressure control.

### BRIEF DESCRIPTION OF DRAWINGS

FIG. 1 is a configuration diagram illustrating a configuration of a first embodiment.

FIG. 2 illustrates conceptual cross-sectional diagrams for describing a volume variable mechanism in the first embodiment.

FIG. 3 illustrates configuration diagrams illustrating the configuration of the first embodiment.

FIG. 4 is a diagram illustrating an output flow rate of a fluid in the first embodiment.

FIG. 5 is a conceptual diagram illustrating an application example of a positive displacement pressurizing/depressurizing pump in the first embodiment.

FIG. 6 illustrates conceptual cross-sectional diagrams for describing a volume variable mechanism in a second embodiment.

FIG. 7 illustrates conceptual cross-sectional diagrams for describing a volume variable mechanism in a third embodiment.

FIG. 8 illustrates conceptual cross-sectional diagrams for describing a volume variable mechanism in a fourth embodiment.

FIG. 9 illustrates conceptual cross-sectional diagrams for describing a volume variable mechanism in a fifth embodiment.

FIG. 10 illustrates conceptual cross-sectional diagrams for describing a volume variable mechanism in a sixth embodiment.

FIG. 11 illustrates conceptual cross-sectional diagrams for describing a volume variable mechanism in a seventh embodiment.

FIG. 12 illustrates conceptual cross-sectional diagrams for describing a volume variable mechanism in an eighth embodiment.

FIG. 13 illustrates conceptual cross-sectional diagrams for describing a volume variable mechanism in a ninth embodiment.

FIG. 14 illustrates conceptual cross-sectional diagrams for describing a volume variable mechanism in a tenth embodiment.

FIG. 15 illustrates conceptual cross-sectional diagrams for describing a volume variable mechanism in an eleventh embodiment.

FIG. 16 illustrates conceptual cross-sectional diagrams for describing a volume variable mechanism in a twelfth embodiment.

### DESCRIPTION OF EMBODIMENTS

Hereinafter, embodiments of the present disclosure will be described based on the drawings. Note that, among the following embodiments, the portions identical or equivalent to each other are denoted by the same reference numerals in the drawings. The descriptions and drawings in the first embodiment can be applied as the descriptions and drawings for corresponding portions in the respective embodiments. Moreover, the respective drawings to be used in the descriptions are conceptual diagrams.

### First Embodiment

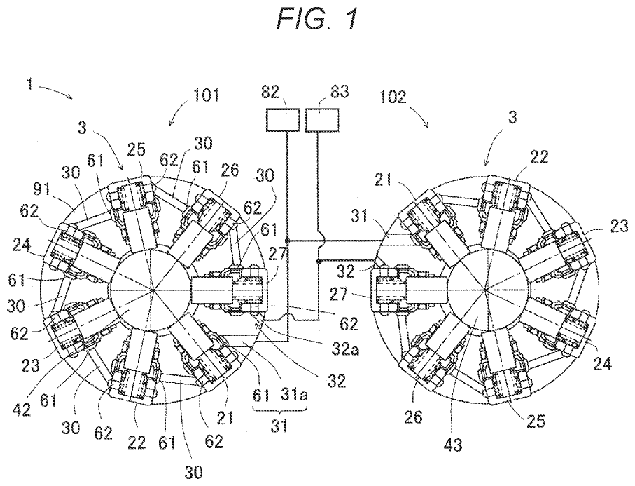

A positive displacement pressurizing/depressurizing pump 1 in the first embodiment is provided with, as illustrated in FIG. 1, a first pump 101, and a second pump 102 that is connected in parallel with the first pump 101. As is described later, the phase of a first cam member 42 of the first pump 101 is different by 180 degrees from the phase of a second cam member 43 of the second pump 102. Because the first pump 101 and the second pump 102 have the same configuration, the first pump 101 will be described as an example.

The first pump 101 is provided with seven fluid delivery portions 21 to 27, a pump flow path 3 formed by the seven fluid delivery portions 21 to 27 being connected in series, a drive device 4, and a housing 9 that is made of metal and accommodates them. The seven fluid delivery portions 21 to 27 are arranged at equal intervals in a circumferential direction of an annular portion 91 of the housing 9. Because the seven fluid delivery portions 21 to 27 mutually have the same configuration, a configuration of the fluid delivery portion 21 will be described. Moreover, in the following description, a radially outer side of the annular portion 91 in the housing 9 is set as “front side”, and a radially inner side of the annular portion 91 is set as “rear side”.

(Fluid Delivery Portion)

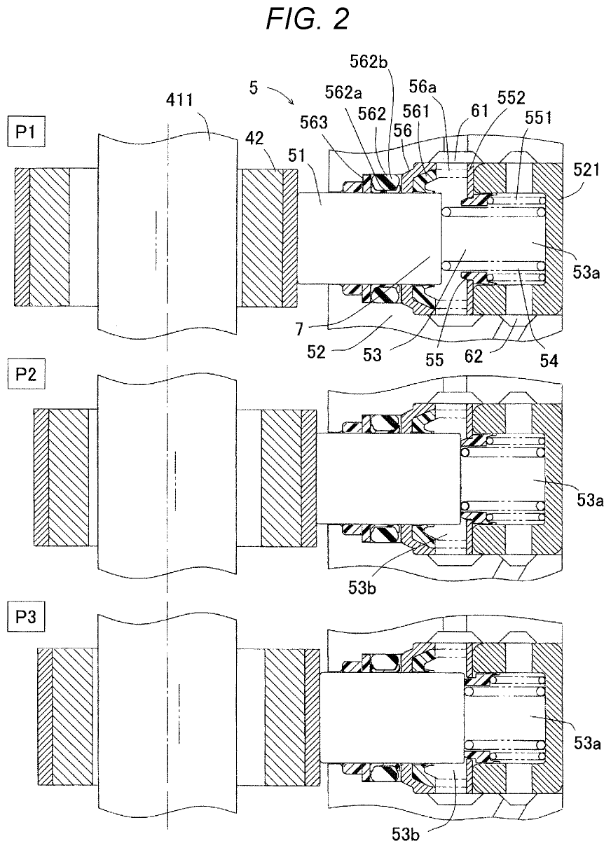

The fluid delivery portion 21 is provided with, as illustrated in FIG. 2, a volume variable mechanism 5, a first port 61, a second port 62, and a valve mechanism 7. The volume variable mechanism 5 is provided with a piston 51, a concave portion 52, a hydraulic chamber 53, an urging member 54, and a sealing member 55. The piston 51 is a cylinder-shaped member made of metal, and is disposed so as to be slidable in a front and rear direction in the concave portion 52. The front and rear direction corresponds to an axis direction of the piston 51.

The concave portion 52 is a part of the housing 9, and is open rearward and has a bottom surface in front. The concave portion 52 is formed such that a plug 521 is fixed into a through hole formed in the housing 9. The plug 521 constitutes the bottom surface of the concave portion 52. The plug 521 is formed in a closed-bottom cylindrical shape that is open rearward and has a bottom surface in front.

The hydraulic chamber 53 is sectioned by the piston 51 and the concave portion 52. The volume of the hydraulic chamber 53 changes in accordance with the movement of the piston 51. As is described later, the hydraulic chamber 53 is sectioned into a front site 53a and a rear site 53b in accordance with the movement of the piston 51. The urging member 54 is a spring disposed between the piston 51 and the plug 521, and urges the piston 51 rearward. A rear end portion of the piston 51 is brought into contact with the first cam member 42, which is described later. The sealing member 55 is an annular member made of resin, and is disposed on an outer circumferential side of the urging member 54. The sealing member 55 is disposed coaxially with the piston 51.

An outer circumferential surface of the sealing member 55 is brought into contact with an inner circumferential surface of the plug 521 so as to be slidable in the axis direction. An urging member 551 is disposed between a front end portion of the sealing member 55 and the bottom surface of the plug 521. The urging member 551 urges the sealing member 55 rearward. An annular plate 552 is disposed on an outer circumferential side of the sealing member 55. The plate 552 is brought into contact with a rear end portion of the plug 521. The plate 552 is brought into contact with the sealing member 55 and positions the sealing member 55 so as not to move rearward. A rear end portion of the sealing member 55 is positioned rearward of the plate 552.

The first port 61 is provided to a site rearward of the plate 552 in the concave portion 52, and is open to the hydraulic chamber 53. The second port 62 is provided to a site in front of the first port 61 in the concave portion 52, and is open to the hydraulic chamber 53. In the plug 521, a through hole corresponding to the second port 62 is provided. The first port 61 is positioned on one side in a circumferential direction of the annular portion 91 in the hydraulic chamber 53, and the second port 62 is positioned on the other side in the circumferential direction of the annular portion 91 in the hydraulic chamber 53.

A cylinder member 56 into which the piston 51 is inserted is disposed behind the first port 61 in the concave portion 52. An annular sealing member 561 (for example, a member made of resin) that is brought into contact with the outer circumferential surface of the piston 51 is disposed on an inner circumferential side of the cylinder member 56. In the outer circumferential surfaces of the cylinder member 56 and the sealing member 561, a through hole 56a corresponding to the first port 61 is formed. The through hole 56a is sectioned by the cylinder member 56, the sealing member 561, and the plate 552. The plate 552 is disposed by being sandwiched between the cylinder member 56 and the plug 521.

Moreover, an annular sealing member 562 that is brought into contact with the outer circumferential surface of the piston 51 is disposed behind the cylinder member 56 in the concave portion 52. The sealing member 562 includes a seal shaft 562a made of resin that is disposed on the inner circumferential side, and an O-ring 562b made of rubber that is disposed on the outer circumferential side. A backup ring 563 made of resin is disposed behind the sealing member 562 in the concave portion 52. In this manner, the sealing members 561 and 562 seal a portion between the hydraulic chamber 53 and the outside while allowing the piston 51 to slide in the front and rear direction.

The valve mechanism 7 is a mechanism that causes the first port 61 to open and close in accordance with the movement of the piston 51. In a case where the piston 51 is present at a rear end position, the first port 61 opens to the entire hydraulic chamber 53, and the first port 61 and the second port 62 communicate with each other. When the piston 51 moves forward from the rear end position and is brought into contact with the sealing member 55, the first port 61 is closed to a site (hereinafter, referred to as the front site 53a) forward of the rear end portion of the sealing member 55 in the hydraulic chamber 53. In other words, in this case, the connection between the first port 61 and the second port 62 via the hydraulic chamber 53 is interrupted. In this manner, the first port 61 opens to the entire hydraulic chamber 53, so that the first port 61 and the second port 62 communicate with each other, and the first port 61 is closed to the front site 53a of the hydraulic chamber 53, so that the first port 61 is interrupted from the second port 62.

(Movement Range of Piston)

The movement range of the piston 51 includes a maximum volume position P1, a minimum volume position P3, and a switching position P2. The maximum volume position P1 is a position where the state of the first port 61 is an open state and the volume of the hydraulic chamber 53 becomes maximum, as illustrated in the upper part of FIG. 2. The minimum volume position P3 is a position where the state of the first port 61 is a closed state and the volume of the hydraulic chamber 53 becomes minimum, as illustrated in the lower part of FIG. 2. The switching position P2 is a position where the state of the first port 61 is switched from the open state to the closed state when the piston 51 has moved from the maximum volume position P1 toward the minimum volume position P3, as illustrated in the middle part of FIG. 2. The valve mechanism 7 is configured to include the piston 51, and a member (the sealing member 55 in the first embodiment) that is brought into contact with the piston 51 at the switching position P2.

The piston 51 reciprocates in the front and rear direction between the maximum volume position P1 that is a rear end of the movement range and the minimum volume position P3 that is a front end of the movement range. The switching position P2 is present between the maximum volume position P1 and the minimum volume position P3. The motion of the piston 51 includes a communication movement process in which the piston 51 moves between the maximum volume position P1 and the switching position P2, and a closing movement process in which the piston 51 moves between the switching position P2 and the minimum volume position P3.

(Drive Device)

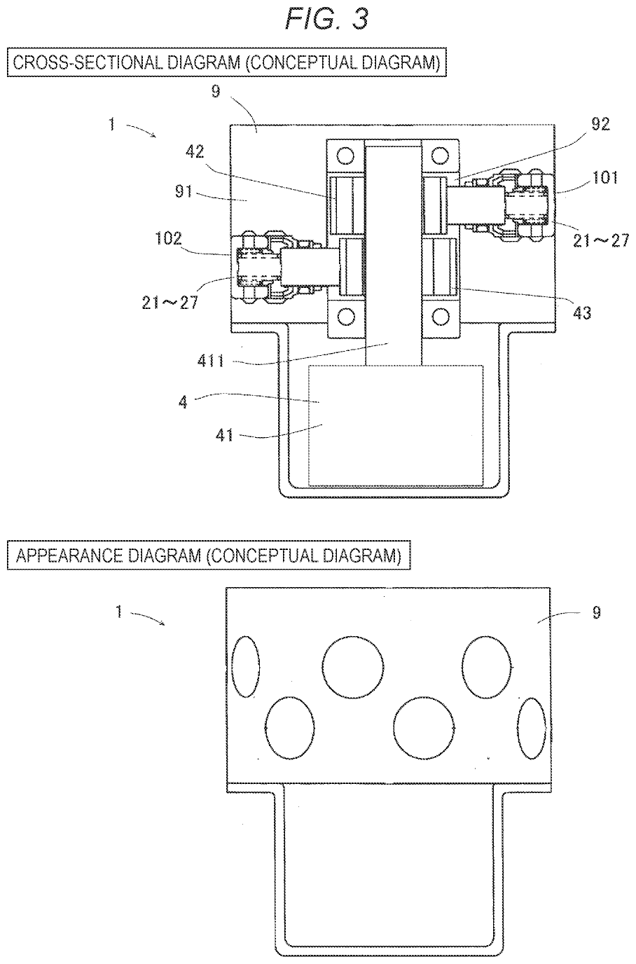

The drive device 4 is a device that causes the piston 51 to move. The drive device 4 is provided with an electric motor 41, the first cam member 42, and the second cam member 43, as illustrated in FIG. 3. The first cam member 42 and the second cam member 43 (hereinafter, also abbreviated as cam members 42 and 43) are fixed to different positions on an output axis 411 of the electric motor 41. The first cam member 42 is brought into contact with the respective pistons 51 in the first pump 101. The second cam member 43 is brought into contact with the respective pistons 51 in the second pump 102.

Each of the cam members 42 and 43 is eccentric with respect to the output axis 411. Each of the cam members 42 and 43 is configured to include an eccentric bearing. The phase of the first cam member 42 is different by 180 degrees from the phase of the second cam member 43. The cam members 42 and 43 are disposed in a housing chamber 92 formed in the center part of the housing 9. The annular portion 91 of the housing 9 is formed in an annular shape by the housing chamber 92. The output axis 411 and the cam members 42 and 43 constitute a cam shaft. Note that, FIG. 3 illustrates a cross-sectional diagram with a cross section being set such that the fluid delivery portions 21 to 27 are displayed in each of the pumps 101 and 102. Moreover, FIG. 2 illustrates the cross-sectional diagrams in which a plane orthogonal to an axis direction of the output axis 411 is used as a cross section.

(Pump Flow Path)

The pump flow path 3 is formed by the three or more (seven in the present embodiment) fluid delivery portions 21 to 27 being connected in series. The connection in series is defined as a state where with respect to two fluid delivery portions, the first port 61 of one of the fluid delivery portions (for example, the fluid delivery portion 22) and the second port 62 of the other fluid delivery portion (for example, the fluid delivery portion 21) are connected to each other. Each flow path 30 that connects the first port 61 and the second port 62 to each other in the connection in series is formed in the housing 9.

A first inlet/outlet port 31 and a second inlet/outlet port 32 as two inlet/outlet ports that open to the outside are formed in the outer circumferential surface of the housing 9. The first port 61 of the fluid delivery portion 21 that is positioned at one end portion in a circumferential direction of the pump flow path 3 constitutes the first inlet/outlet port 31. The first inlet/outlet port 31 includes the first port 61 of the fluid delivery portion 21, and a flow path 31a that connects the outer circumferential surface of the housing 9 and the first port 61 to each other. The second port 62 of the fluid delivery portion 27 that is positioned at the other end portion in the circumferential direction of the pump flow path 3 constitutes the second inlet/outlet port 32. The second inlet/outlet port 32 includes the second port 62 of the fluid delivery portion 27, and a flow path 32a that connects the outer circumferential surface of the housing 9 and the second port 62 to each other.

(Motion of Fluid Delivery Portion)

When the output axis 411 of the electric motor 41 rotates and the cam members 42 and 43 rotate, the pistons 51 that are respectively brought into contact with the cam members 42 and 43 move in the front and rear direction. The motion will be described using the first cam member 42 as an example. A maximum eccentric portion that is a site most distant from the output axis 411 in the first cam member 42 rotationally move with the rotation of the output axis 411. In a case where the maximum eccentric portion of the first cam member 42 is brought into contact with the piston 51, the piston 51 is positioned at the minimum volume position P3.

A minimum eccentric portion that is a site closest to the output axis 411 in the first cam member 42 has a phase different by 180 degrees from that of the maximum eccentric portion, and rotationally moves with the rotation of the output axis 411. In a case where the minimum eccentric portion of the first cam member 42 is brought into contact with the piston 51, the piston 51 is positioned at the maximum volume position P1. The output axis 411 rotates, whereby a state where the piston 51 is positioned at the maximum volume position P1 or at the minimum volume position P3 is sequentially shifted in the circumferential direction with respect to the fluid delivery portions 21 to 27 that are arranged in the circumferential direction. Accordingly, a state where the piston 51 is positioned at the switching position P2 is also sequentially shifted in the circumferential direction with respect to the fluid delivery portions 21 to 27.

In this manner, the pump flow path 3 is configured such that the closing movement process in which the piston 51 moves between the switching position P2 and the minimum volume position P3 by the drive of the drive device 4 is sequentially shifted from the first inlet/outlet port 31 toward the second inlet/outlet port 32 or from the second inlet/outlet port 32 toward the first inlet/outlet port 31, among the fluid delivery portions 21 to 27.

For example, in the first pump 101 of FIG. 1, in a case where the first cam member 42 has rotated in a clockwise direction, the closing movement process is shifted in the order from the fluid delivery portion 21, the fluid delivery portion 22, the fluid delivery portion 23, the fluid delivery portion 24, the fluid delivery portion 25, the fluid delivery portion 26, the fluid delivery portion 27, to the fluid delivery portion 21. The closing movement process can simultaneously occur, for example, in the two adjacent fluid delivery portions among the fluid delivery portions 21 to 27. By the driving the drive device 4, at least one among the fluid delivery portions 21 to 27 executes the closing movement process.

In a case where the closing movement process has been shifted from the fluid delivery portion 21 to the fluid delivery portion 22, the fluid in the hydraulic chamber 53 of the fluid delivery portion 21 flows into the hydraulic chamber 53 of the fluid delivery portion 23 via the hydraulic chamber 53 of the fluid delivery portion 22. In other words, the closing movement process is sequentially shifted in the clockwise direction among the fluid delivery portions 21 to 27, whereby the fluid is sucked into the pump flow path 3 from the first inlet/outlet port 31, and is discharged from the second inlet/outlet port 32.

On the contrary, the closing movement process is sequentially shifted in the counter-clockwise direction among the fluid delivery portions 21 to 27, whereby the fluid is sucked into the pump flow path 3 from the second inlet/outlet port 32, and is discharged from the first inlet/outlet port 31. Further, in the case of the first embodiment, due to the reason on the configuration, which is described later, the fluid discharge amount per one rotation by the first cam member 42 in the clockwise direction is larger than that in the counter-clockwise direction.

(Details of Closing Movement Process)

As illustrated in FIG. 2, when the piston 51 moves from the switching position P2 to the minimum volume position P3, the piston 51 presses the sealing member 55 forward. Further, the piston 51 and the sealing member 55 in a contact state move forward. Accordingly, in a state where the front site 53a of the hydraulic chamber 53 is interrupted from the first port 61, the volume of the front site 53a is reduced. In other words, in accordance with the reduction in the volume of the front site 53a, the fluid in the front site 53a is sent out from the second port 62 to the first port 61 of the adjacent fluid delivery portion 21 to 27.

When this principle is used, in a case where the rotation direction of the first cam member 42 is the clockwise direction, the fluid in the front site 53a of the fluid delivery portion 21 is sent out from the second port 62 to the first port 61 of the fluid delivery portion 22 in accordance with the reduction in the volume of the front site 53a. The piston 51 of the fluid delivery portion 22 starts the closing movement process after the piston 51 of the fluid delivery portion 21 has started the closing movement process. In other words, a timing at which the closing movement process in the fluid delivery portion 21 overlaps the communication movement process in the fluid delivery portion 22 is present. Accordingly, the fluid moves in the clockwise direction one after the other.

Meanwhile, when the piston 51 moves from the minimum volume position P3 to the switching position P2, in a state where the front site 53a is interrupted from the first port 61, the volume of the front site 53a is increased. Accordingly, in accordance with an increase in the volume of the front site 53a, the fluid is sucked from the first port 61. When this principle is used, in a case where the rotation direction of the first cam member 42 is the counter-clockwise direction, in accordance with an increase in the volume of the front site 53a in the fluid delivery portion 21, the fluid is sent out from the first port 61 of the fluid delivery portion 22 to the second port 62 of the fluid delivery portion 21. Similar to the clockwise direction, the fluid moves in the counter-clockwise direction one after the other. Further, in a case where the rotation direction of the first cam member 42 is the counter-clockwise direction, when the piston 51 moves from the switching position P2 to the minimum volume position P3, the fluid is sent out (flows back) also in the clockwise direction. Accordingly, the fluid discharge amount per one rotation by the first cam member 42 in the clockwise direction becomes larger than that in the counter-clockwise direction.

(Parallel Connection between First Pump And Second Pump)

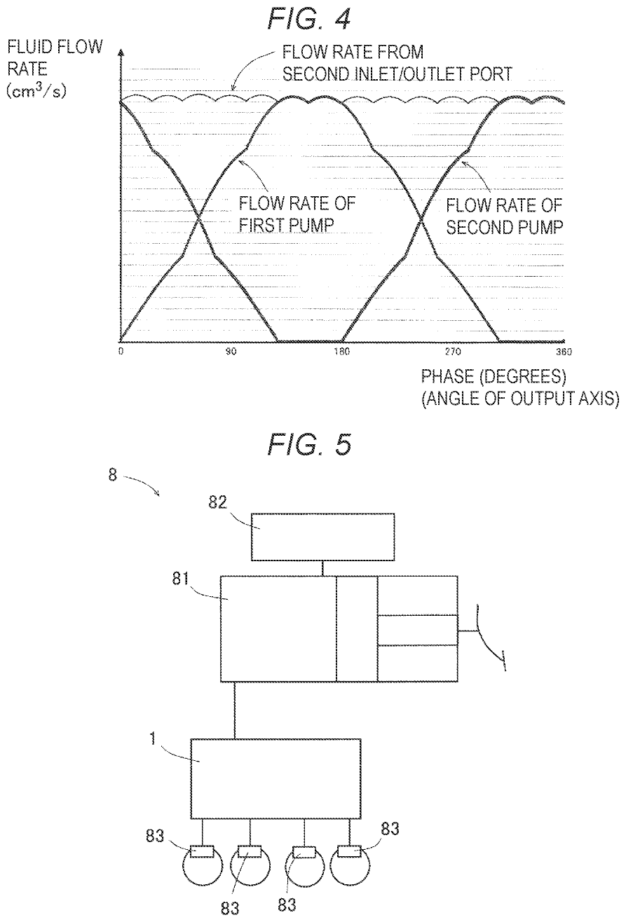

In the positive displacement pressurizing/depressurizing pump 1, a plurality of the pump flow paths 3 having different phases are connected in parallel with each other. In the first embodiment, the first pump 101 and the second pump 102 having a phase (phase of the cam) different by 180 degrees from that of the first pump 101 are connected in parallel with each other. In other words, the first inlet/outlet port 31 of the first pump 101 is connected to the first inlet/outlet port 31 of the second pump 102, and the second inlet/outlet port 32 of the first pump 101 is connected to the second inlet/outlet port 32 of the second pump 102. The two first inlet/outlet ports 31 constitute one first inlet/outlet port 31 of the positive displacement pressurizing/depressurizing pump 1, and the two second inlet/outlet ports 32 constitute one second inlet/outlet port 32 of the positive displacement pressurizing/depressurizing pump 1. As illustrated in FIG. 4, the two pumps 101 and 102 having phases different by 180 degrees from each other are connected in parallel with each other to smooth the output of the positive displacement pressurizing/depressurizing pump 1.

(Application Example of Positive Displacement Pressurizing/Depressurizing Pump)

The positive displacement pressurizing/depressurizing pump 1 can be applied to a vehicle braking device 8, as illustrated in FIG. 5. The vehicle braking device 8 is provided with a master cylindrical portion 81, a reservoir 82, the positive displacement pressurizing/depressurizing pump 1, and wheel cylinders 83. The first inlet/outlet port 31 of the positive displacement pressurizing/depressurizing pump 1 is connected to the reservoir 82 via the master cylindrical portion 81. The second inlet/outlet port 32 of the positive displacement pressurizing/depressurizing pump 1 is connected to the wheel cylinders 83.

Each of the pumps 101 and 102 of the positive displacement pressurizing/depressurizing pump 1 is operated in the clockwise direction, whereby the fluid is sucked from the reservoir 82 via the first inlet/outlet port 31 into each of the pump flow paths 3 with time difference in accordance with the phase difference, and is sent out from each of the pump flow paths 3 via the second inlet/outlet port 32 to the wheel cylinders 83. Accordingly, the positive displacement pressurizing/depressurizing pump 1 can pressurize the wheel cylinders 83. In the configuration of the first embodiment, the first port 61 is preferably connected to a liquid path (the reservoir 82) at a relatively low-pressure side, and the second port 62 is preferably connected to a liquid path (the wheel cylinders 83) at a relatively high-pressure side.

Each of the pumps 101 and 102 in the positive displacement pressurizing/depressurizing pump 1 is operated in the counter-clockwise direction, whereby the fluid is sucked from the wheel cylinders 83 via the second inlet/outlet port 32 into each of the pump flow paths 3 with a time difference in accordance with the phase difference, and is sent out from each of the pump flow paths 3 via the first inlet/outlet port 31 to the master cylindrical portion 81 and the reservoir 82. Accordingly, the positive displacement pressurizing/depressurizing pump 1 can depressurize the wheel cylinders 83.

(Configuration Summary of First Embodiment)

The positive displacement pressurizing/depressurizing pump 1 in the first embodiment is provided with: the fluid delivery portions 21 to 27 each including the volume variable mechanism 5 that is configured to change the volume of the hydraulic chamber 53 with the movement of the piston 51, the first port 61 and the second port 62 that are open to the hydraulic chamber 53, and the valve mechanism 7 that causes the first port 61 to open and close in accordance with the movement of the piston 51; the pump flow path 3 that is formed by the three or more fluid delivery portions 21 to 27 being connected in series to each other; and the drive device 4 that causes each of the pistons 51 to move. The first port 61 of the fluid delivery portion 21 that is positioned at one end portion of the pump flow path 3 constitutes the first inlet/outlet port 31, and the second port 62 of the fluid delivery portion 27 that is positioned at the other end portion of the pump flow path 3 constitutes the second inlet/outlet port 32. The movement range of each of the pistons 51 includes the maximum volume position P1, the minimum volume position P3, and the switching position P2. The pump flow path 3 is configured such that the closing movement process (movement between P2-P3) in which the piston 51 moves between the switching position P2 and the minimum volume position P3 by the drive of the drive device 4 is sequentially shifted from the first inlet/outlet port 31 toward the second inlet/outlet port 32 or from the second inlet/outlet port 32 toward the first inlet/outlet port 31 among the fluid delivery portions 21 to 27.

### Effect of First Embodiment

With the present embodiment, when the closing movement process is executed, the piston 51 changes the volume of the hydraulic chamber 53 (the front site 53a) while interrupting the pump flow path 3. Due to the reduction in the volume of the hydraulic chamber 53 in the closing movement process, the fluid is discharged from the second port 62, whereas due to the increase in the volume of the hydraulic chamber 53 in the closing movement process, the fluid is sucked from the second port 62. The execution of the closing movement process in each of the fluid delivery portions 21 to 27 is sequentially shifted in the pump flow path 3, whereby the fluid is sucked from one inlet/outlet port and is discharged into the other inlet/outlet port. Accordingly, an object of hydraulic pressure control can be pressurized until the fluid in the fluid suction object (for example, the reservoir 82) is run out. In a case where the object of hydraulic pressure control is depressurized, the drive device 4 may be driven such that the closing movement process is shifted in the reverse order of the pressurization. In this manner, with the first embodiment, it is possible to increase the limit value of pressurization without upsizing the device, and pressurize/depressurize the object of hydraulic pressure control.

Moreover, a front end surface of the sealing member 55 receives a pressing force by the hydraulic pressure of the front site 53a. In other words, the sealing member 55 is pressed rearward by the hydraulic pressure as the hydraulic pressure in the front site 53a of the hydraulic chamber 53 becomes high. Accordingly, when the hydraulic pressure in the front site 53a becomes high in a state where the sealing member 55 and the piston 51 are brought into contact with each other, a sealing force between the piston 51 and the sealing member 55 is improved. The sealing member 55 is configured to be self-sealed with respect to the closing of the first port 61 in a case where the front site 53a is at high pressure. With the connection in FIG. 5, in the closing movement process, the front site 53a receives an influence of the hydraulic pressure of the wheel cylinders 83 that are assumed to be at relatively high pressure, and the site (the rear site 53b) on the first port 61 side receives an influence of the hydraulic pressure of the master cylindrical portion 81 or the reservoir 82.

### Second Embodiment

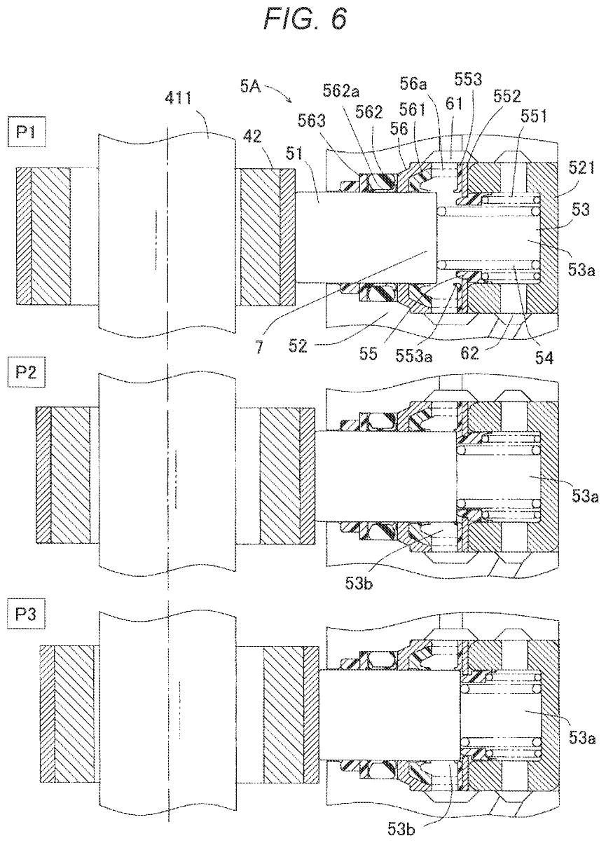

A volume variable mechanism 5A in a second embodiment will be described with reference to FIG. 6. The volume variable mechanism 5A has a configuration in which a sealing member 553 is added to the volume variable mechanism 5 in the first embodiment. The sealing member 553 is an annular resin member, and is brought into contact with a rear end surface of the plate 552. The sealing member 553 is disposed by being sandwiched between the cylinder member 56 and the plate 552.

A lip portion 553a curved rearward is formed in an inner circumferential portion of the sealing member 553. The piston 51 slides in an inner side of the sealing member 553 in the closing movement process (movement between P2-P3). At this time, when the rear site 53b becomes high-pressure, the lip portion 553a is pressed toward the piston 51 to improve the sealing force. In other words, in a case where the rear site 53b has become high-pressure, the sealing member 553 is configured to be self-sealed with respect to the closing of the first port 61. Note that, in a case where the front site 53a has become high-pressure, similar to the first embodiment, the sealing member 55 exhibits the self-seal function. A motion of the positive displacement pressurizing/depressurizing pump in the second embodiment is similar to that in the first embodiment.

### Third Embodiment

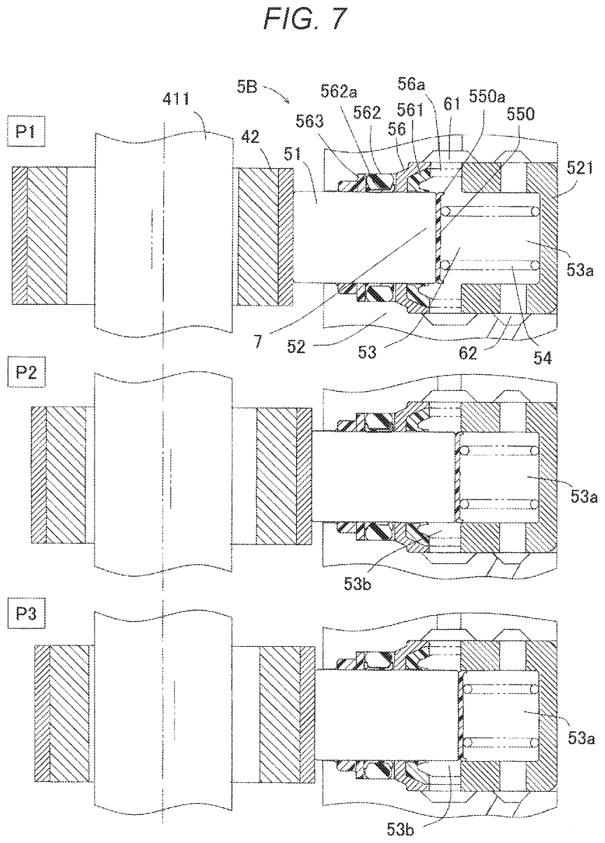

In a volume variable mechanism 5B in a third embodiment, as illustrated in FIG. 7, a sealing member 550 is disposed on a front end surface of the piston 51. The sealing member 550 is a disc-shaped resin member. A curved-forward lip portion 550a is formed on an outer circumferential portion of the sealing member 550. The sealing member 550 is urged rearward by the urging member 54. In the volume variable mechanism 5B, none of the sealing member 55, the urging member 551, and the plate 552 in the first embodiment are provided.

In the third embodiment, the switching position P2 is a position (contact start position) at which the lip portion 550a of the sealing member 550 is brought into contact with the inner circumferential surface of the plug 521, in a state where the piston 51 is moving forward from the maximum volume position P1. In the closing movement process (movement between P2-P3), in a case where the front site 53a has become high-pressure, the lip portion 550a is pressed against the inner circumferential surface of the plug 521 to improve the sealing force. In other words, in a case where the front site 53a has become high-pressure, the sealing member 550 exhibits the self-seal function. The piston 51 moves forward in the closing movement process, whereby the fluid is sent out from the second port 62. A motion of the positive displacement pressurizing/depressurizing pump in the third embodiment is similar to that in the first embodiment.

### Fourth Embodiment

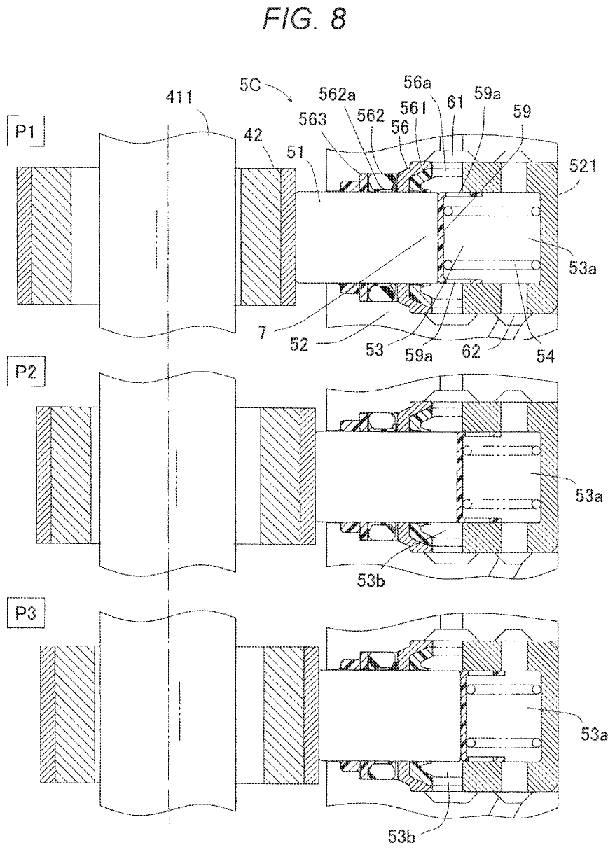

A volume variable mechanism 5C in a fourth embodiment is configured by replacing the sealing member 550 in the third embodiment with a valve seal 59, as illustrated in FIG. 8. The valve seal 59 is a closed-bottom cylindrical resin member that is open forward and has a bottom surface at the rear. A plurality of through holes 59a are formed on an outer circumferential surface of the valve seal 59.

In the communication movement process (movement between P1-P2), the fluid can circulate between the first port 61 and the second port 62 via the through holes 59a. The valve seal 59 is disposed by being sandwiched between the front end surface of the piston 51 and the urging member 54. The valve seal 59 is urged rearward by the urging member 54.

The switching position P2 is a position (through hole closing position) at which all the through holes 59a are entirely positioned at the inner circumferential side of the plug 521, in a state where the piston 51 is moving forward from the maximum volume position P1. In the closing movement process (movement between P2-P3), the piston 51 moves in a state where the through holes 59a are closed, that is, a state where the first port 61 is closed. The piston 51 moves forward in the closing movement process, whereby the fluid is sent out from the second port 62. A motion of the positive displacement pressurizing/depressurizing pump in the fourth embodiment is similar to that in the first embodiment. In other words, also with the configuration, similar to the first embodiment, the object of hydraulic pressure control can be pressurized/depressurized.

### Fifth Embodiment

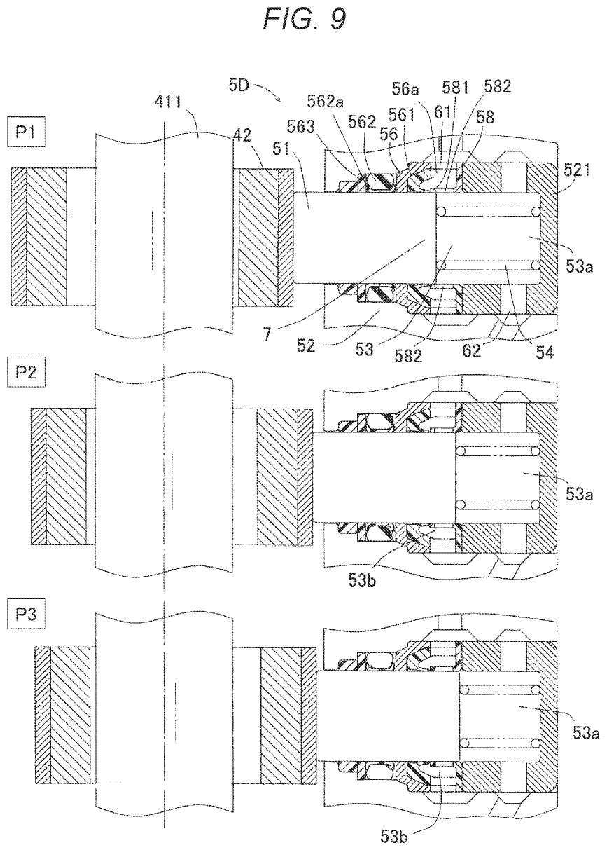

A volume variable mechanism 5D in a fifth embodiment is configured by replacing the valve seal 59 in the fourth embodiment with a valve seal 58, as illustrated in FIG. 9. The valve seal 58 is an annular resin member. A cylindrical portion 581 that extends rearward is formed in an inner circumferential portion of the valve seal 58. A plurality of through holes 582 are formed in the cylindrical portion 581. The valve seal 58 is brought into contact with a rear end surface of the plug 521.

In the communication movement process (movement between P1-P2), the fluid can circulate between the first port 61 and the second port 62 via the through holes 582. At the switching position P2, all the through holes 582 are closed by the piston 51. In the closing movement process (movement between P2-P3), the piston 51 moves in a state where the through holes 582 are closed, that is, a state where the first port 61 is closed. The piston 51 moves forward in the closing movement process, whereby the fluid is sent out from the second port 62. A motion of the positive displacement pressurizing/depressurizing pump in the fifth embodiment is similar to that in the first embodiment. In other words, also with the configuration, similar to the first embodiment, the object of hydraulic pressure control can be pressurized/depressurized.

### Sixth Embodiment

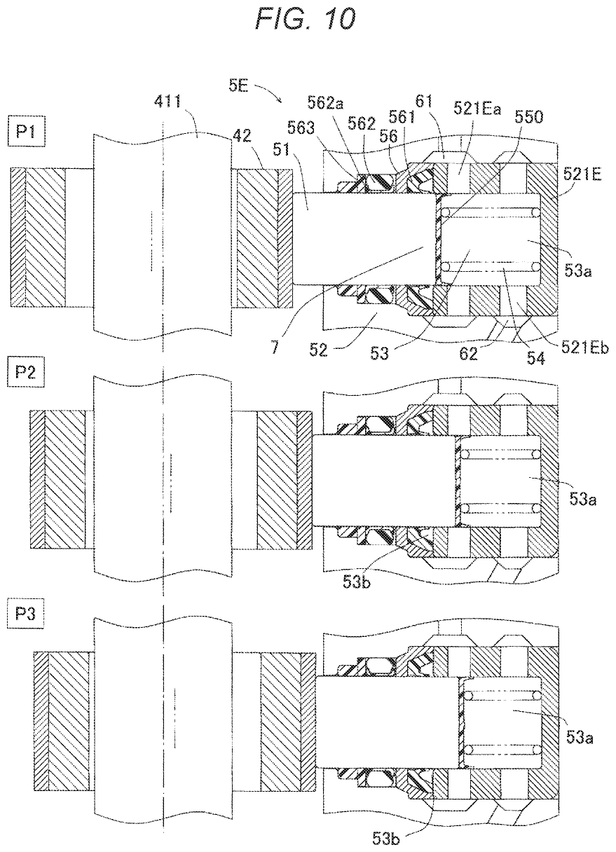

A plug 521E of a volume variable mechanism 5E in a sixth embodiment has a configuration in which a tubular portion of the plug 521 in the third embodiment is extended to a position facing the first port 61, as illustrated in FIG. 10. In the plug 521E, a plurality of through holes 521Ea corresponding to the first port 61 and a plurality of through holes 521Eb corresponding to the second port 62 are formed.

At the maximum volume position P1, the sealing member 550 is positioned behind the through holes 521Ea. In the communication movement process (movement between P1-P2), the first port 61 and the second port 62 communicate with each other via the through holes 521Ea and 521Eb. At the switching position P2, the piston 51 and the sealing member 550 entirely close all the through holes 521Ea. In the closing movement process (movement between P2-P3), the piston 51 moves in a state where the through holes 521Ea are closed, that is, a state where the first port 61 is closed. The piston 51 moves forward in the closing movement process, whereby the fluid is sent out from the second port 62. A motion of the positive displacement pressurizing/depressurizing pump in the sixth embodiment is similar to that in the first embodiment. In other words, also with the configuration, similar to the first embodiment, the object of hydraulic pressure control can be pressurized/depressurized.

### Seventh Embodiment

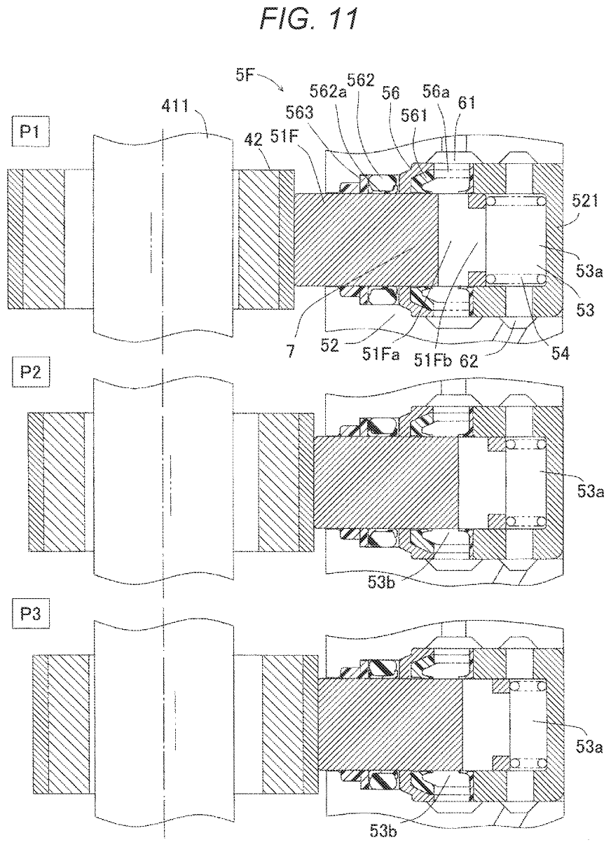

A volume variable mechanism 5F in a seventh embodiment is configured by eliminating the sealing member 55, the urging member 551, and the plate 552 from the second embodiment, and replacing the piston 51 with a piston 51F, as illustrated in FIG. 11. In a front end portion of the piston 51F, a through hole 51Fa that extends in a direction intersecting an axis direction of the piston 51F, and a liquid path 51Fb that causes the through hole 51Fa and the front site 53a to communicate with each other are formed. Note that, in FIG. 11, for clearer illustration of the flow path, the piston 51F is hatched.

In the communication movement process (movement between P1-P2), the first port 61 and the second port 62 communicate with each other via the through hole 51Fa and the liquid path 51Fb. At the switching position P2, the through hole 51Fa is entirely closed by the sealing member 553 and the plug 521. In the closing movement process (movement between P2-P3), the piston 51F moves in a state where the through hole 51Fa is closed, that is, a state where the first port 61 is closed.

The piston 51F moves forward in the closing movement process, whereby the fluid is sent out from the second port 62. A motion of the positive displacement pressurizing/depressurizing pump in the seventh embodiment is similar to that in the first embodiment. Also with the configuration, similar to the first embodiment, the object of hydraulic pressure control can be pressurized/depressurized. Note that, in the seventh embodiment, preferably, the first port 61 is connected to a relatively high-pressure liquid path (for example, the wheel cylinders 83), and the second port 62 is connected to a relatively low-pressure liquid path (for example, the reservoir 82).

### Eighth Embodiment

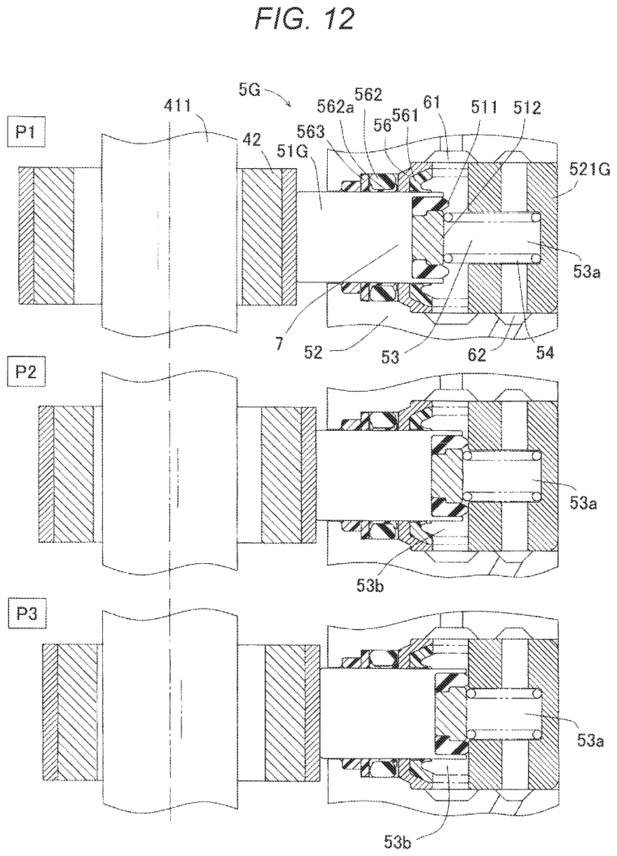

A volume variable mechanism 5G in an eighth embodiment is configured by replacing the piston 51F in the seventh embodiment with a piston 51G, replacing the plug 521 with a plug 521G, and eliminating the sealing member 553, as illustrated in FIG. 12.

In a front end portion of the piston 51G, a concave portion that is open forward is formed. In the concave portion of the piston 51G, an annular valve seal 511 made of rubber and a stopper 512 made of metal are disposed. The stopper 512 is disposed on an inner circumferential side of the valve seal 511, and is engaged with the valve seal 511 in the front and rear direction. A front end portion of the valve seal 511 protrudes forward of the stopper 512 and the concave portion of the piston 51G. The urging member 54 is brought into contact with the stopper 512, and urges the piston 51G rearward via the stopper 512.

The plug 521G is configured so as to face the valve seal 511 in the front and rear direction. In other words, the inner diameter of the plug 521G is smaller than the inner diameter of the plug 521 in the seventh embodiment, and is smaller than the diameter of the piston 51G.

In the communication movement process (movement between P1-P2), the valve seal 511 and the plug 521G are separated from each other, and the first port 61 and the second pump 102 communicate with each other. At the switching position P2, the valve seal 511 and the plug 521G are brought into contact with each other, and the first port 61 is closed. In the closing movement process (movement between P2-P3), the valve seal 511 elastically deforms in accordance with the movement of the piston 51G, whereby the piston 51G moves in a state where the first port 61 is closed. The piston 51G moves forward in the closing movement process, whereby the fluid is sent out from the first port 61 and the second port 62. A motion of the positive displacement pressurizing/depressurizing pump in the eighth embodiment is similar to that in the first embodiment. In other words, also with the configuration, similar to the first embodiment, the object of hydraulic pressure control can be pressurized/depressurized.

### Ninth Embodiment

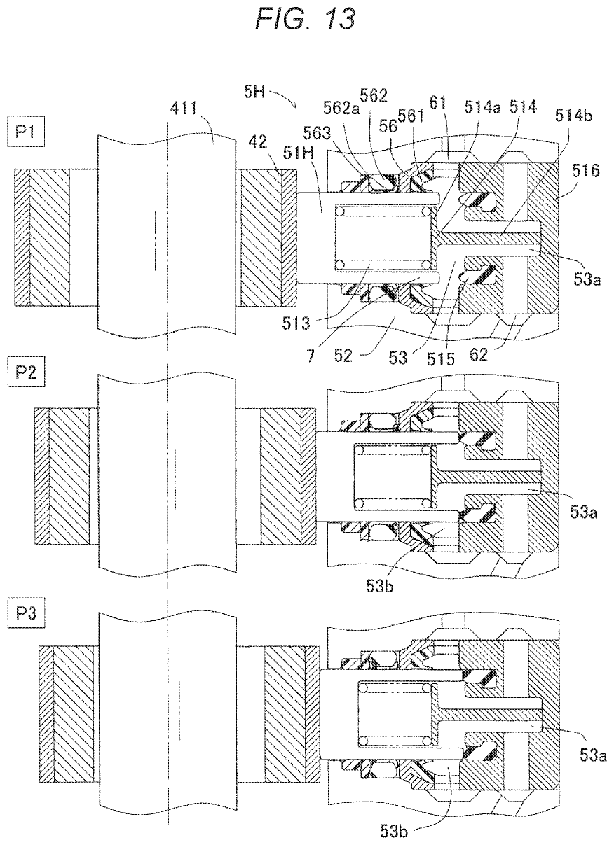

A volume variable mechanism 5H in a ninth embodiment is provided with a piston 51H, an urging member 513, a stopper 514, a valve seal 515, and a plug 516, as illustrated in FIG. 13. The piston 51H is formed in a closed-bottom cylindrical shape that is open forward and has a bottom surface at the rear. The urging member 513 is disposed to an inner side of the piston 51H. The stopper 514 is disposed between the urging member 513 and a bottom surface of the plug 516. The stopper 514 includes a rear end portion 514a formed in a disc shape, and a rod-like portion 514b that extends forward from the rear end portion 514a. The urging member 513 being supported by the stopper 514 urges the piston 51H rearward.

The valve seal 515 is an annular rubber member, and is fixed to the plug 516 so as to face an annular front end portion of the piston 51H. A rear end portion of the valve seal 515 is positioned rearward of a rear end surface of the plug 516. The inner diameter of the plug 516 is smaller than the inner diameter of the plug 521 in the first embodiment, and is smaller than the diameter of the piston 51H. Note that, the volume variable mechanism 5H is provided with the cylinder member 56, the sealing members 561 and 562, and the backup ring 563, similar to the first embodiment.

In the communication movement process (movement between P1-P2), the piston 51H and the valve seal 515 are separated from each other, the first port 61 and the second port 62 communicate with each other. At the switching position P2, the piston 51H and the valve seal 515 are brought into contact with each other, and the first port 61 is closed. In the closing movement process (movement between P2-P3), the valve seal 515 elastically deforms in accordance with the movement of the piston 51H, whereby the piston 51H moves in a state where the first port 61 is closed. The piston 51H moves forward in the closing movement process, whereby the fluid is sent out from the first port 61 and the second port 62. A motion of the positive displacement pressurizing/depressurizing pump in the ninth embodiment is similar to that in the first embodiment. In other words, also with the configuration, similar to the first embodiment, the object of hydraulic pressure control can be pressurized/depressurized.

### Tenth Embodiment

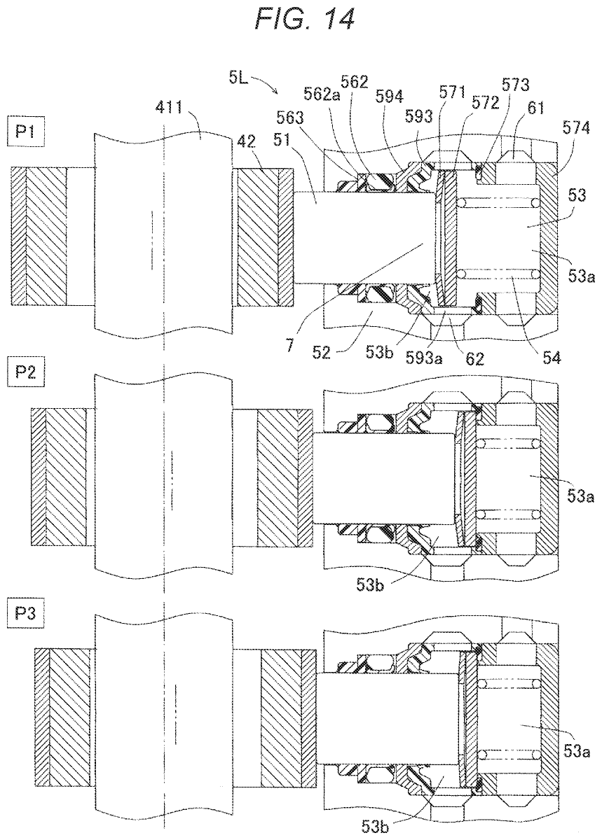

A volume variable mechanism 5L in a tenth embodiment is provided with the piston 51, a disc spring 571, a plate 572, the urging member 54, a sealing member 573, a plug 574, a sealing member 593, and a cylinder member 594, as illustrated in FIG. 14. The disc spring 571 is an annular metal member. The disc spring 571 can also be referred to as a plate spring. The disc spring 571 is formed so as to be further rearward as it goes closer to the inner circumference. The disc spring 571 is disposed by being sandwiched between the front end surface of the piston 51 and the plate 572. An inner circumferential edge of the disc spring 571 is brought into contact with the front end surface of the piston 51. The disc spring 571 elastically deforms in accordance with the movement of the piston 51.

The plate 572 is a disc-shaped member made of metal, and is disposed between the disc spring 571 and the urging member 54. The plate 572 is urged rearward by the urging member 54. The sealing member 573 is an annular rubber member that is fixed to a front end surface of the plug 574. The sealing member 573 is disposed by being sandwiched between the plug 574 and the sealing member 593 so as to face an outer circumferential edge of the plate 572. A rear end portion of the sealing member 573 is positioned rearward of the plug 574. The inner diameter of the plug 574 is larger than the inner diameter of the plug 521 in the first embodiment, and is larger than the diameter of the piston 51.

The sealing member 593 is a cylindrical member made of resin. A lip is formed on an inner circumferential surface in a rear end portion of the sealing member 593 so as to be brought into contact with the outer circumferential surface of the piston 51. In the sealing member 593, a through hole 593a is formed so as to correspond to the second port 62. A front end portion of the sealing member 593 is brought into contact with the plug 574 and the sealing member 573. The cylinder member 594 is a cylindrical member made of metal, and is disposed between the sealing member 593 and the sealing member 562.

The volume variable mechanism 5L is provided with the cylinder member 56, the sealing member 562, and the backup ring 563, similar to the first embodiment. Moreover, in the tenth embodiment, unlike the first embodiment, the first port 61 is provided on the front side in the concave portion 52, and the second port 62 that is a main discharge port is provided on the rear side in the concave portion 52. In the tenth embodiment, preferably, the first port 61 is connected to a liquid path (for example, the reservoir 82) at a relatively low-pressure side, and the second port 62 is connected to liquid path (for example, the wheel cylinders 83) at a relatively high-pressure side.

In the communication movement process (movement between P1-P2), the plate 572 and the sealing member 573 are separated from each other, and the first port 61 and the second port 62 communicate with each other. At the switching position P2, the plate 572 and the sealing member 573 are brought into contact with each other, and the first port 61 is closed with respect to the rear site 53b of the hydraulic chamber 53.

In the closing movement process (movement between P2-P3), in a state where the first port 61 is closed, the disc spring 571 elastically deforms in accordance with the movement of the piston 51. This changes the volume of the rear site 53b. Moreover, the sealing member 573 also elastically deforms in accordance with the movement of the piston 51, whereby the volume of the front site 53a also changes, although the changing amount is relatively small.

In a case where the piston 51 is moving forward in the closing movement process, the disc spring 571 deforms into a flat plate shape to reduce the volume of the rear site 53b, whereby the fluid is discharged from the second port 62. Moreover, in this case, the plate 572 presses and deforms the sealing member 573, whereby the plate 572 slightly moves forward, and the fluid is slightly discharged from the front site 53a of the hydraulic chamber 53 to the first port 61. Also with the configuration, similar to the first embodiment, the object of hydraulic pressure control can be pressurized/depressurized.

Moreover, with the configuration of the tenth embodiment, it is possible to increase the flow path cross-sectional area of a flow path that connects the first port 61 and the second port 62 to each other, and reduce the flow resistance of the fluid. The tenth embodiment has a configuration in which the inner diameter of the plug 574, that is, the flow path cross-sectional area of the flow path is easily increased.

For example, in the configuration of the first embodiment, in a case where the inner diameter of the sealing member 55 is increased to increase the flow path cross-sectional area, the inner diameter of the plug 521 needs to be increased. In addition, in order to press the sealing member 55, the diameter of the front end surface of the piston 51 also needs to be increased. As the diameter of the piston 51 is increased more, the piston 51 receives a larger rearward pressing force by the hydraulic pressure when moving forward in the closing movement process. Accordingly, the pressing force to the piston 51 in the closing movement process is increased, and the load on the cam members 42 and 43, that is, the load on the electric motor 41 is increased.

However, with the tenth embodiment, the second port 62 is open to the rear site 53b of the hydraulic chamber 53, so that the rear site 53b becomes relatively high-pressure in the closing movement process. The front end surface of the piston 51 receives the rearward pressing force to be received by the piston 51 due to the hydraulic pressure (relatively high-pressure) in the closing movement process. With the tenth embodiment, the pressing force at the relatively high-pressure is determined depending on the diameter of the piston 51, and the diameter of the piston 51 can be set independent of the inner diameter of the plug 574. With the tenth embodiment, without increasing the load on the piston 51, it is possible to increase the inner diameter of the plug 574 and increase the flow path cross-sectional area of the flow path.

### Eleventh Embodiment

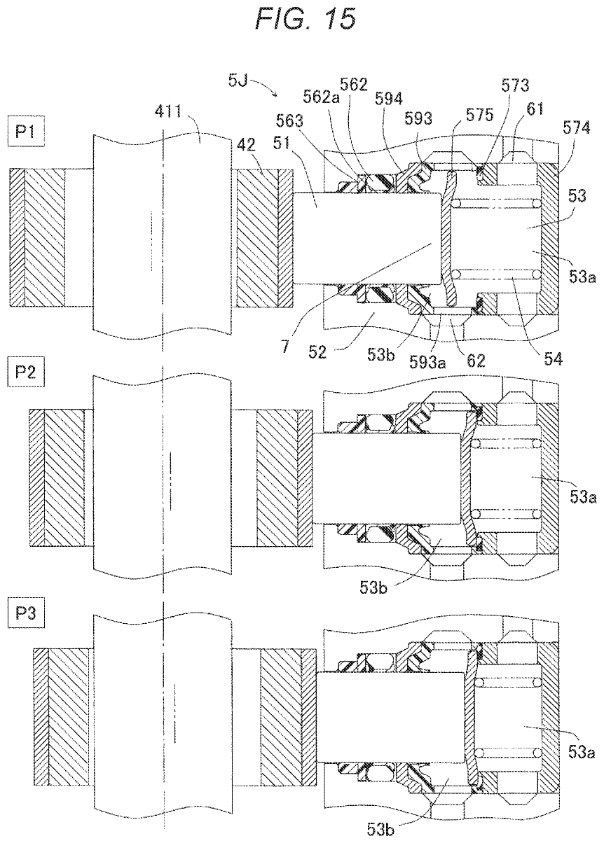

A volume variable mechanism 5J in an eleventh embodiment is configured by replacing the disc spring 571 and the plate 572 in the tenth embodiment with a disc spring 575, as illustrated in FIG. 15. The disc spring 575 is made of metal, and has a shape in which a disc-shaped central portion is inflated rearward. The disc spring 575 is disposed by being sandwiched between the piston 51 and the urging member 54. The sealing member 573 is fixed to the plug 574 so as to face an outer circumferential edge of the disc spring 575. The rear end portion of the sealing member 573 is positioned rearward of the plug 574.

In the communication movement process (movement between P1-P2), the disc spring 575 and the sealing member 573 are separated from each other, and the first port 61 and the second port 62 communicate with each other. At the switching position P2, the disc spring 575 and the sealing member 573 are brought into contact with each other, and the first port 61 is closed with respect to the rear site 53b of the hydraulic chamber 53.

In the closing movement process (movement between P2-P3), in a state where the first port 61 is closed, the disc spring 575 elastically deforms in accordance with the movement of the piston 51. This changes the volume of the rear site 53b. Moreover, the sealing member 573 also elastically deforms in accordance with the movement of the piston 51, whereby the volume of the front site 53a also changes, although the changing amount is relatively small. In other words, in the closing movement process, the piston 51 moves forward, whereby the fluid is sent out from the second port 62, and the fluid of a relatively small amount is also sent out from the first port 61. With the eleventh embodiment, an effect similar to that in the tenth embodiment is exhibited.

### Twelfth Embodiment

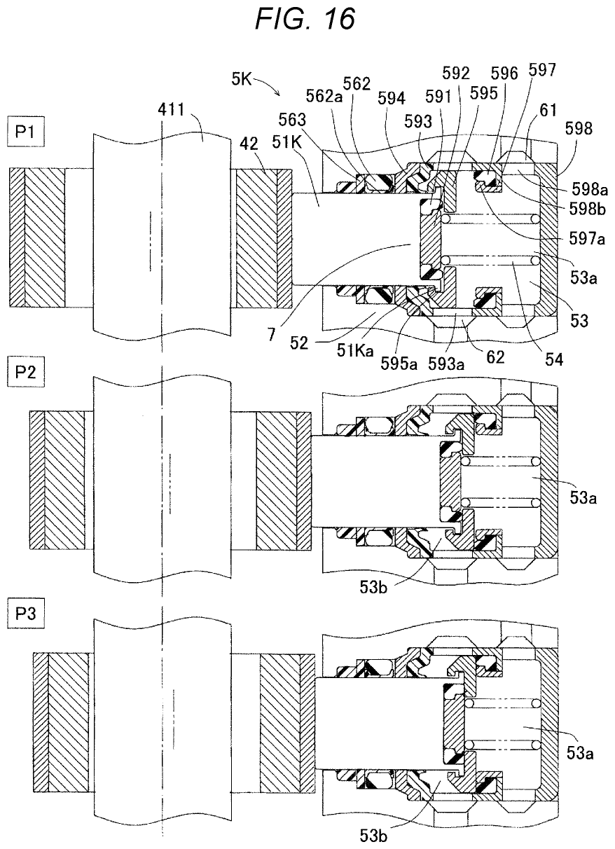

A volume variable mechanism 5K in a twelfth embodiment is provided with a piston 51K, a valve seal 591, a stopper 592, the sealing member 593, the cylinder member 594, a plate 595, a valve seal 596, a stopper 597, and a plug 598, as illustrated in FIG. 16. In the twelfth embodiment, similar to the tenth embodiment, the first port 61 is open to the front site 53a of the hydraulic chamber 53, and the second port 62 is open to the rear site 53b of the hydraulic chamber 53. Note that, the volume variable mechanism 5K is provided with the sealing member 562 and the backup ring 563, similar to the first embodiment.

In a front end portion of the piston 51K, a concave portion that is open forward is formed. The valve seal 591 is an annular member made of rubber that is disposed in the concave portion of the piston 51K. The stopper 592 is disposed on an inner circumferential side of the valve seal 591, and engages with the valve seal 591 in the front and rear direction. A front end portion of the valve seal 591 protrudes forward of the stopper 592 and the concave portion of the piston 51K. The urging member 54 is brought into contact with the stopper 592, and urges the piston 51K rearward via the stopper 592.

The sealing member 593 is a cylindrical member made of resin. The lip is formed on the inner circumferential surface in the rear end portion of the sealing member 593 so as to be brought into contact with the outer circumferential surface of the piston 51K. In the sealing member 593, the through hole 593a is formed so as to correspond to the second port 62. The front end portion of the sealing member 593 is brought into contact with the plug 598. The cylinder member 594 is a cylindrical member made of metal, and is disposed between the sealing member 593 and the sealing member 562.

The plate 595 is a disc-shaped member made of metal. An inner circumferential portion of the plate 595 is disposed in front of the valve seal 591 so as to face the valve seal 591. An outer circumferential portion of the plate 595 is disposed behind the valve seal 596 so as to face the valve seal 596. In a front end portion of the piston 51K, a protrusion portion 51Ka that protrudes outward in a radial direction is formed. In a rear end portion of the plate 595, a concave portion 595a that engages with the protrusion portion 51Ka in the front and rear direction is formed. The protrusion portion 51Ka is disposed in the concave portion 595a so as to be relative movable in the front and rear direction only by a predetermined amount with respect to the concave portion 595a.

The plug 598 includes a through hole 598a corresponding to the first port 61, and constitutes the bottom surface of the concave portion 52. In a rear end portion (rearward of the through hole 598a) of the plug 598, in order to dispose the valve seal 596, a protrusion portion 598b that protrudes inward in the radial direction is formed.

The valve seal 596 is an annular member made of rubber. The valve seal 596 is brought into contact with a rear end surface of the protrusion portion 598b of the plug 598 and an inner circumferential surface of the rear end portion of the plug 598. The stopper 597 is a cylindrical member made of metal. The stopper 597 is brought into contact with an inner circumferential surface of the valve seal 596 and an inner circumferential surface of the protrusion portion 598b. In an outer circumferential surface of the stopper 597, a protrusion portion 597a that protrudes outward in the radial direction is provided. The stopper 597 engages with the valve seal 596 in the front and rear direction with the protrusion portion 597a. The stopper 597 is press-fitted and fixed to the protrusion portion 598b of the plug 598, for example. The valve seal 596 is fixed to the plug 598 with the stopper 597. A rear end portion of the valve seal 596 is positioned rearward of the rear end portion of the stopper 597.

At the maximum volume position P1, the valve seal 591 and the plate 595 are separated from each other, and the valve seal 596 and the plate 595 are also separated from each other. When the piston 51K moves forward from the maximum volume position P1, the piston 51K approaches the plate 595, and the valve seal 591 is brought into contact with the plate 595. Thereafter, in the communication movement process (movement between P1-P2), as the piston 51K moves forward, the plate 595 also moves forward.

When the piston 51K moves forward and reaches the switching position P2, the plate 595 is brought into contact with the valve seal 596. At the switching position P2, the first port 61 and the second port 62 are interrupted by the piston 51K, the plate 595, and the valve seals 591 and 596. In other words, the opening of the first port 61 is closed with respect to the rear site 53b of the hydraulic chamber 53.

In the closing movement process (movement between P2-P3), as the piston 51K moves forward, the valve seal 591 elastically deforms, and the volume of the rear site 53b is reduced. Accordingly, the fluid is discharged from the second port 62. Moreover, at this time, as the piston 51K moves forward, the valve seal 596 also elastically deforms, and the volume of the front site 53a is also reduced, although the changing amount is relatively small. Accordingly, the fluid of a minute amount is discharged also from the first port 61. When the piston 51K moves rearward, because the protrusion portion 51Ka of the piston 51K and the concave portion 595a of the plate 595 are engaged with each other, as the piston 51K moves rearward, the plate 595 moves rearward.

In the twelfth embodiment, the inner diameter (flow path width) of the stopper 597 is larger than the diameter of the piston 51K. In the closing movement process, the piston 51K receives a rearward pressing force due to the hydraulic pressure of the rear site 53b, at the front end surface (protrusion portion 51Ka). Accordingly, an increase in the inner diameter of the stopper 597 has no influence on the pressure receiving area of the piston 51K with respect to the hydraulic pressure (for example, wheel pressure) of the rear site 53b. In other words, also with the configuration, similar to the tenth embodiment, without increasing the load on the piston 51K, it is possible to increase the flow path width in the hydraulic chamber 53. Moreover, as described the above, also with the configuration, the object of hydraulic pressure control can be pressurized/depressurized.

<Others>

The present disclosure is not limited to the abovementioned embodiments. For example, the number of the fluid delivery portions is not limited to seven, but may be three or more. From the viewpoint of the output waveform (stable supply) of the fluid, the number of the fluid delivery portions is preferably seven or more. Moreover, the difference in phase between the pumps 101 and 102 does not need to be 180 degrees. Moreover, the positive displacement pressurizing/depressurizing pump may include one pump 101.

1. A positive displacement pressurizing/depressurizing pump comprising:
a fluid delivery portion including a volume variable mechanism that is configured so as to change a volume of a hydraulic chamber with movement of a piston, a first port and a second port that are open to the hydraulic chamber, and a valve mechanism that causes the first port to open and close in accordance with the movement of the piston;
a pump flow path, when connection in series is defined as a state where with respect to the two fluid delivery portions, the first port of one of the fluid delivery portions is connected to the second port of the other fluid delivery portion, formed by the three or more fluid delivery portions being connected in series; and
a drive device that causes each of the pistons to move, wherein
the first port of the fluid delivery portion that is positioned at one end portion of the pump flow path constitutes a first inlet/outlet port,
the second port of the fluid delivery portion that is positioned at the other end portion of the pump flow path constitutes a second inlet/outlet port,
a movement range of each of the pistons includes a maximum volume position at which a state of the first port is an open state and the volume of the hydraulic chamber becomes maximum, a minimum volume position at which the state of the first port is a closed state and the volume of the hydraulic chamber becomes minimum, and a switching position at which the state of the first port is switched from the open state to the closed state when the piston has moved from the maximum volume position toward the minimum volume position, and
the pump flow path is configured such that a closing movement process in which the piston moves between the switching position and the minimum volume position by driving of the drive device is sequentially shifted from the first inlet/outlet port toward the second inlet/outlet port or from the second inlet/outlet port toward the first inlet/outlet port among the fluid delivery portions.

2. The positive displacement pressurizing/depressurizing pump according to claim 1, wherein a plurality of the pump flow paths having different phases are connected in parallel with each other.
